(19) United States
(12) Patent Application Publication
(10) Pub. No.: US 2024/0334884 A1
(43) Pub. Date: Oct. 10, 2024

(54) LIGHT REFLECTOR FOR PLANTS

(71) Applicant: Heath Frey, Warren, OH (US)

(72) Inventor: Heath Frey, Warren, OH (US)

(21) Appl. No.: 18/130,680

(22) Filed: Apr. 4, 2023

(51) Int. Cl. A01G 9/24; A01G 9/02; F21V 7/10; F21V 7/24; F21V 33/00

(52) U.S. Cl. CPC A01G 9/02; A01G 9/249

(57) ABSTRACT

A light reflector for plants in a planter including a planter pot having a circular base and side walls which extend up from the base to a rim which extends around the top opening of the pot. A reflector having a circular shape with an elastic waist band which forms a circular opening which grips the side walls and engages the bottom surface of the rim whereby the reflector extends outward from the sidewalls to reflect light on a bottom surface of the plants.

### TECHNICAL FIELD OF THE INVENTION

The present invention is directed to light reflector for plants and more particularly to a light reflector for plants which are grown in a pot so that the light is reflected to the bottom of the plant.

### BACKGROUND OF THE INVENTION

Present-day grow lights are positioned on top of the plants which provide approximately one hundred and eighty degrees (180°) of coverage. Secondly, the lights on the market now disperse the light from a single finite source, such as a light fixture. Due to the configuration of the presently used lights, the grow light wavelength is disbursed either on top of or in front of the canopy. These light fixtures also generate heat which can be detrimental to the plants.

The present invention relates to an indoor plant pot capable of intensively supplying high-temperature sunlight to plants planted in pots during a period of incidence of sunlight in a room having a low amount of sunshine. The indoor plant pot is arranged to be planted to plant the plant, and the upper portion of the pot body is arranged at a constant height is provided to collect the sunlight incident to the room according to the movement trajectory of the sun at various locations Solar condensing unit, the solar light dissipation is arranged at a constant height in the upper end of the pot body so as to correspond to the solar condensing unit is provided so that the solar light condensed to the surface by the solar condensing member to the plant side And a portion of the solar light concentrating part and the solar light emitting part at a predetermined height at the upper end of the flower pot main body to condense the sunlight at various positions and emit the light toward the plant side. It is composed of a mounting member detachably mounted. According to the indoor pots configured as described above, by intensively supplying high temperature sunlight for a short time to plants grown indoors with a small amount of sunshine, growth can be promoted through activation of photosynthesis on the plants.

### SUMMARY OF THE INVENTION

According to one embodiment of the present invention, there is disclosed a light reflector for plants in a planter including a flower pot having a circular base and side walls which extend up from the base to a rim which extends around the top opening of the pot. A reflector having a circular shape with an elastic waist band which forms a circular opening which grips the side walls and engages the bottom surface of the rim whereby the reflector extends outward from the sidewalls to reflect light on a bottom surface of the plants.

According to another embodiment of this invention, there is disclosed a novel light reflector for plants in a planter including a reflective ring of reflective insulation. The reflective ring constructed as a circle of reflective insulation of multiple sizes. The reflective ring has a split extending from an outer edge surface of the reflective ring to a central opening through reflective ring. An upper surface of the reflective ring is installed on a flower pot whereby light which projects downward toward the pot reflects upward and off of the top surface of the reflective ring toward plants being grown in the pot.

### BRIEF DESCRIPTION OF THE DRAWINGS

The structure, operation, and advantages of the present invention will become further apparent upon consideration of the following description taken in conjunction with the accompanying figures (Figs.). The figures are intended to be illustrative, not limiting. Certain elements in some of the figures may be omitted, or illustrated not-to-scale, for illustrative clarity. The cross-sectional views may be in the form of “slices”, or “near-sighted” cross-sectional views, omitting certain background lines which would otherwise be visible in a “true” cross-sectional view, for illustrative clarity.

In the drawings accompanying the description that follows, both reference numerals and legends (labels, text descriptions) may be used to identify elements. If legends are provided, they are intended merely as an aid to the reader, and should not in any way be interpreted as limiting.

FIG. 1 shows a side three dimensional view, partly in cross section, of a light reflector for plants secured to a pot for plants, in accordance with the present invention.

FIG. 2 shows a top view of a light reflector having a elastic band around a center opening for securing the light reflector to the outer surface of the pot for plants, in accordance with the present invention.

FIG. 3 shows a top view of a light reflector to be installed on a flower pot for plants, in accordance with the present invention.

FIG. 4 shows a top view of the ring assembly shown adapted to be mounted to the underside of the light reflector for plants shown in FIG. 3, in accordance with the present invention.

FIG. 5 shows a side view of the ring assembly with prong wires for securing the ring assembly into the growing medium in a flower pot, in accordance with the present invention.

### DETAILED DESCRIPTION OF THE PREFERRED EMBODIMENTS

In the description that follows, numerous details are set forth in order to provide a thorough understanding of the present invention. It will be appreciated by those skilled in the art that variations of these specific details are possible while still achieving the results of the present invention. Well-known processing steps are generally not described in detail in order to avoid unnecessarily obfuscating the description of the present invention.

In the description that follows, exemplary dimensions may be presented for an illustrative embodiment of the invention. The dimensions should not be interpreted as limiting. They are included to provide a sense of proportion. Generally speaking, it is the relationship between various elements, where they are located, their contrasting compositions, and sometimes their relative sizes that is of significance.

In the drawings accompanying the description that follows, often both reference numerals and legends (labels, text descriptions) will be used to identify elements. If legends are provided, they are intended merely as an aid to the reader and should not in any way be interpreted as limiting.

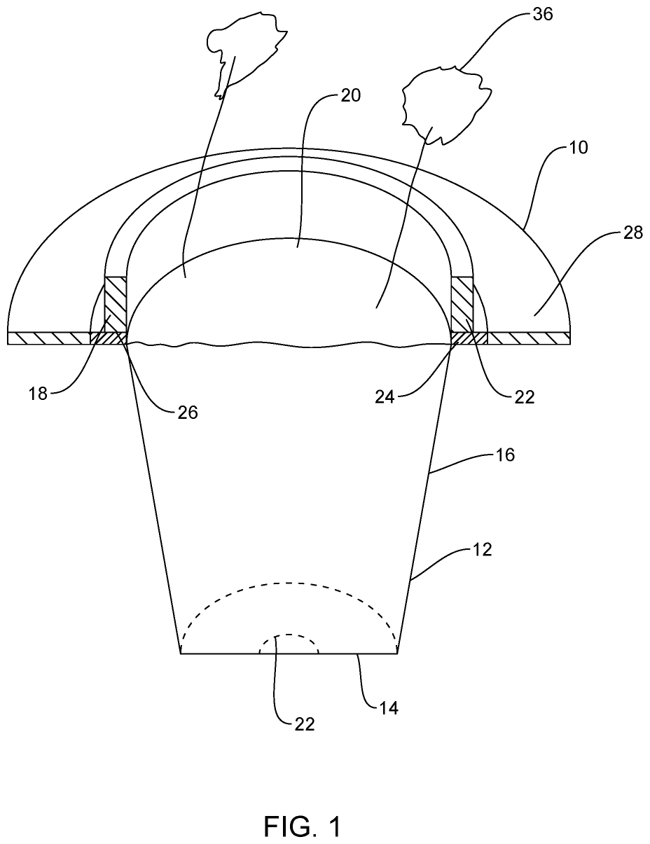

Referring to FIG. 1, there is illustrated a side, three dimensional view, partly in cross section, of a light reflector 10 for plants secured in a flower pot or planter 12. The flower pot 12 typically has a circular base 14 with an opening 22 therethrough and side walls 16 which extend up from the base to a rim 18 which extends around the opening 20 of the pot.

The reflector 10 can have a circular shape with an elastic waist band 22 which forms a circular opening 24 which grips the side walls 16 and preferably engages the bottom surface 26 of the rim 18 to hold the reflector in place.

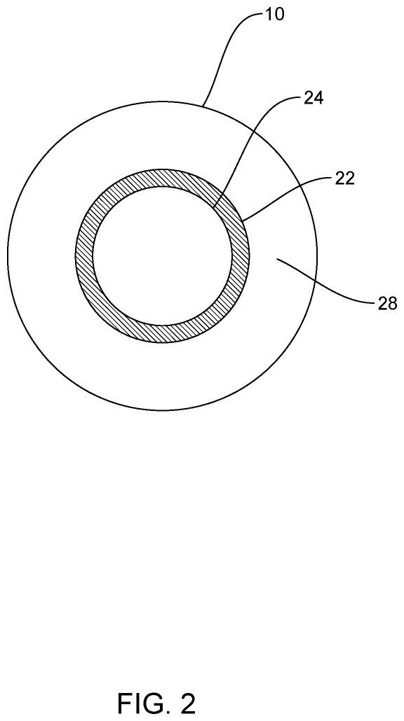

The reflective ring 10 can be made of a reflective insulation. The reflective ring can be constructed as a circle of reflective material of multiple sizes. An elastic band 22 can be formed on the inner side of the opening, such as a circle, of the reflective insulation 10 as shown in FIGS. 1 and 2. The advantage of the reflective ring 10 of FIG. 2 is that it can be easily installed on a flower pot as shown in FIG. 1. The reflective ring 10 can be formed as a circle, or as flower petal shaped cut-outs projecting from the elastic band 22.

When the reflective ring 10 is installed on a flower pot 12, the light which projects downward toward the pot, either from the sun of a light fixture, reflects upward and off of the top surface 28 of the reflective ring 10 toward plants 30 being grown in the pot 12.

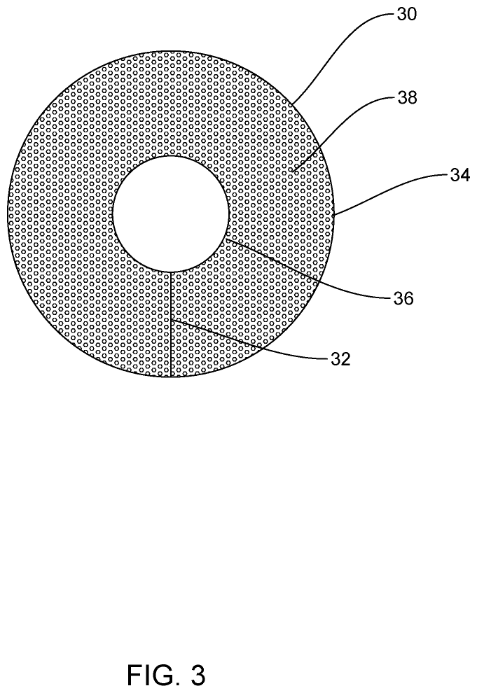

Referring to FIG. 3, there is shown a reflective ring 30, compare reflective insulation 10, can be constructed as a circle of reflective material of multiple sizes. As shown in FIG. 3, the reflective ring 30 has a split 32 extending from the outer edge surface 34 of the reflective ring 30 to a central opening 36 through reflective ring 30. The reflective ring 30 can be opened along split 32 to insert a plant through the central opening 36 through reflective ring 30. The upper surface 38 of the reflective ring 30 is installed on a flower pot 12, the light which projects downward toward the pot, either from the sun of a light fixture, reflects upward and off of the top surface 38 of the reflective ring 30 toward plants 30 being grown in the pot 12.

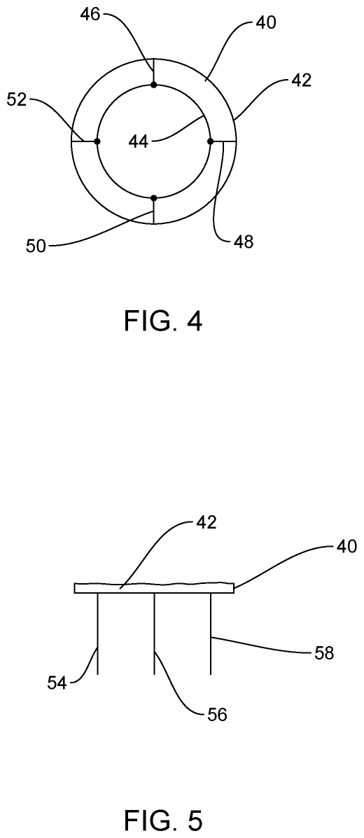

Referring to FIG. 4, there is illustrated a ring assembly 40 constructed of two rings of wire, an outer ring 42 and an inner ring 44. The two rings of wire 40 are interconnected by four connecting strips of wire 46, 48, 50 and 52 (46-52) that interconnect the two rings 42 and 44. Referring to FIG. 5, there is illustrated a side view of the ring assembly 40 shown in FIG. 4 having a plurality of prongs, preferably 4 prongs, attached to the outer ring 42 or the inner ring 44. The prongs 46-52 secure the ring assembly 40 in place when they are inserted into dirt or other mediums in the flower pot 12.

Ring assembly 40 can be secured to the bottom of the a reflective ring 30 and thereby mounted to the top of the flower pot so that the ring 30 faces the bottom of the plant when it is opened along split 32 to insert a plant through the central opening 36 through reflective ring 30.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

1. A light reflector for plants being grown in a planter pot, comprising:
the planter pot having a circular base and side walls which extend up from the base to a rim which extends around the top opening of the pot;.
the light reflector having a circular shape with an elastic waist band which forms a circular opening which grips the side walls and engages the bottom surface of the rim whereby the light reflector extends outward from the sidewalls to reflect light on a bottom surface of the plants.

2. The light reflector for plants of claim 1 with an opening through a circular base of the planter pot.

3. The light reflector for plants of claim 1 wherein the light reflector is constructed of a reflective insulation.

4. The light reflector for plants of claim 3 wherein the light reflector can be constructed as a circle of reflective material of multiple sizes.

5. The light reflector for plants of claim 4 wherein the light reflector has an elastic band formed on the inner side of the circular opening of the reflective insulation.

6. The light reflector for plants of claim 5 wherein the light reflector is formed as a circle projecting out from the elastic band.

7. The light reflector for plants of claim 6 wherein the light reflector is installed on a flower pot whereby light which projects downward toward the planter pot reflects upward and off of a top surface of the reflective ring toward plants being grown in the pot.

8. The light reflector for plants of claim 7 wherein the light which projects downward toward the planter pot is from a light fixture.

9. The light reflector for plants of claim 7 wherein the light which projects downward toward the planter pot is sunlight.

10. A light reflector for plants being grown in a planter pot, comprising:
the light reflector being a reflective ring of reflective insulation;
the reflective ring constructed as a circle of reflective insulation of multiple sizes;
the reflective ring having split extending from an outer edge surface of the reflective ring to a central opening through reflective ring;
an upper surface of the reflective ring is installed on the planter pot whereby light which projects downward toward the pot reflects upward and off of the top surface of the reflective ring toward plants being grown in the pot.

11. The light reflector for plants of claim 10 with an opening through the circular base of the planter pot.

12. The light reflector for plants of claim 10 wherein the the reflective ring has an elastic band formed on the inner side of the central opening of the reflective insulation.

13. The light reflector for plants of claim 12 wherein the the reflective ring is formed as a circle projecting out from the elastic band.

14. The light reflector for plants of claim 13 wherein the the reflective ring is installed on the planter pot whereby light which projects downward toward the planter pot reflects upward and off of a top surface of the reflective ring toward plants being grown in the planter pot.

15. The light reflector for plants of claim 14 wherein the light which projects downward toward the planter pot is from a light fixture.

16. The light reflector for plants of claim 14 wherein the light which projects downward toward the planter pot is sunlight.

17. The light reflector for plants of claim 14 including a ring assembly mounted to the underside of the reflective ring.

18. The light reflector for plants of claim 17 wherein the ring assembly is constructed of an outer ring and an inner ring of wire.

19. The light reflector for plants of claim 18 wherein the outer ring and the inner ring of wire are interconnected by four connecting strips of wire.

20. The light reflector for plants of claim 19 wherein the ring assembly has a plurality of prongs to secure the ring assembly in place when the prongs are inserted into a medium in the planter pot.
